(19) United States
(12) Patent Application Publication
(10) Pub. No.: US 2019/0325715 A1
(43) Pub. Date: Oct. 24, 2019

(54) KINESTHETIC HAPTIC FEEDBACK FOR HAPTICALLY-ENABLED SURFACES

(71) Applicant: Immersion Corporation, San Jose, CA (US)

(72) Inventors: Vahid KHOSHKAVA, Laval (CA); Juan Manuel CRUZ-HERNANDEZ, Westmount (CA)

(21) Appl. No.: 16/389,522

(22) Filed: Apr. 19, 2019

Related U.S. Application Data
(60) Provisional application No. 62/660,801, filed on Apr. 20, 2018.

(51) Int. Cl. G08B 6/00; G06F 3/01; B29C 65/48

(52) U.S. Cl. CPC G08B 6/00; B29L 2031/3475; B29C 65/483; G06F 3/016

(57) ABSTRACT

A haptic system and a method of manufacturing a haptic system are provided. The haptic system includes a substrate and a haptic actuator. The substrate includes a region having a residual stress. The haptic actuator is associated with the substrate on or near the region and is configured to generate a haptic effect in response to receiving a haptic effect signal. The haptic effect generated by the haptic actuator is amplified by the residual stress associated with the region. The method of manufacturing the haptic system includes deforming an substrate into a deformed shape, applying an epoxy to the substrate, affixing a haptic actuator to the epoxy and curing the epoxy while holding the substrate in the deformed shape, and, after curing, releasing the substrate to create the region having the residual stress.

### CROSS-REFERENCE TO RELATED APPLICATIONS

This application claims priority to U.S. Provisional Application Ser. No. 62/660,801, filed on Apr. 20, 2018, the contents of which are incorporated herein by reference in their entirety.

### TECHNICAL FIELD

The embodiments are generally directed to electronic devices, and more particularly, to a variety of electronic device types that include one or more haptically-enabled surfaces.

### BACKGROUND

Electronic devices, such as mobile devices, personal computers, home video game consoles, handheld video game consoles, automobile consoles, etc., typically use visual and auditory cues to provide feedback to a user. In some electronic devices, kinesthetic feedback and/or tactile feedback may be provided to the user. Kinesthetic feedback is known as “kinesthetic haptic feedback” or “kinesthetic haptic effects,” and may include, for example, active and resistive force feedback. Tactile feedback is known as “tactile haptic feedback” or “tactile haptic effects,” and may include, for example, vibration, texture, temperature variation, etc. In general, kinesthetic and tactile feedback are collectively known as “haptic feedback” or “haptic effects.” Haptic effects provide cues that enhance a user's interaction with an electronic device, from augmenting simple alerts to specific events to creating a greater sensory immersion for the user within an augmented, simulated or virtual environment, such as, for example, a gaming environment.

In general, an application executed by the operating system (“OS”) or real time operating system (“RTOS”) of the electronic device sends commands to one or more haptic actuators to generate haptic effects. For example, when a user interacts with a touchscreen of the electronic device, or a touchscreen of a separate device coupled to the electronic device, such as, for example, a video game controller, etc., the application sends commands to the haptic actuators to produce haptic effects that are perceived by the user. Unfortunately, many haptically-enabled surfaces fail to adequately deliver haptic effects to the user, such as, for example, low frequency haptic effects.

### SUMMARY

Embodiments of the present invention advantageously provide a haptic system that includes a substrate (e.g., a surface) in connection with a haptic actuator. The substrate includes a region having a residual stress. The haptic actuator is coupled to the substrate on or near the region and is configured to generate a haptic effect in response to receiving a haptic effect signal. The haptic effect generated by the haptic actuator is amplified by the residual stress associated with the region.

Embodiments of the present invention advantageously provide a method of manufacturing a haptic system. A substrate is deformed into a deformed shape. While holding the substrate in the deformed shape, an epoxy is applied to the substrate, a haptic actuator is affixed to the epoxy, and the epoxy is cured. After the epoxy has cured, the substrate is released to create a region in the substrate having a residual stress. The haptic actuator is configured to generate a haptic effect in response to receiving a haptic effect signal, and the haptic effect is amplified by the residual stress associated with the region.

### BRIEF DESCRIPTION OF THE DRAWINGS

FIGS. 1 and 2 depict a haptic system, in accordance with an example embodiment of the present invention.

FIG. 3 depicts the haptic system of FIGS. 1 and 2 producing a low frequency haptic effect, in accordance with an example embodiment of the present invention.

FIG. 4 depicts a rectangular substrate producing a low frequency haptic effect, in accordance with an example embodiment of the present invention.

FIGS. 5, 6A, 6B, and 6C present graphs of measured frequency (Z direction) and acceleration data (X, Y and Z directions), respectively, for a frequency sweep of the haptic system depicted in FIGS. 1 and 2, in accordance with example embodiments of the present invention.

FIG. 7 depicts the direction and magnitude of output forces produced by the haptic system depicted in FIGS. 1 and 2, in accordance with an example embodiment of the present invention.

FIG. 8 is a block diagram of a haptically-enabled device, in accordance with an example embodiment of the present invention.

FIG. 9 depicts a flow chart illustrating functionality for manufacturing a haptic system, in accordance with an example embodiment of the present invention.

### DETAILED DESCRIPTION

Reference will now be made in detail to embodiments, examples of which are illustrated by the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of haptically-enabled substrates and associated methods for fabricating the haptically-enabled substrates are described. In the various embodiments described herein, the substrate of a haptically-enabled surface may be part of a variety of electronic device types, including a portable communication device, mobile phone, tablet, wearable device, augmented or virtual reality device, smart watch, haptically-enabled eyeglasses, haptically-enabled fabrics (e.g., clothing, seat upholstery for gaming chair or automobile seat, etc.), game console, automobile panel, steering wheel, etc. The user interfaces associated with the haptically-enabled substrate may include a display, touch screen, gyroscopic or other acceleration device, vibratory warning system (e.g., to provide a warning or alert to a driver) and/or other input/output devices. It should be further understood that the haptically-enabled surfaces, user interfaces, and associated methods may be applied to other device types, such as piano keys or musical instruments, personal computers or laptops, and may include one or more other physical user-interface devices, such as a keyboard and or mouse.

Embodiments of the present invention advantageously provide a haptic system that includes a substrate (e.g., a surface, layer, body, structure. etc.) and a haptic actuator. The substrate includes a region having a residual stress. The haptic actuator is associated with or coupled to (e.g., adhered to, adjacent to, affixed to, attached to, bonded to, connected to, directly or indirectly coupled to, physically coupled to, functionally coupled to, embedded to, joined to, in an adjacent plane to, linked to, near to, spaced apart from, etc.) the substrate on or near the region and is configured to generate a haptic effect in response to receiving a haptic effect signal. The haptic effect generated by the haptic actuator is advantageously amplified by the residual stress associated with the region. In other words, the force produced by the residual stress is added to or otherwise combined with the force produced by the haptic actuator. For example, the force produced by the residual stress and the force produced by the haptic actuator may be applied in the same direction resulting in the rendering of an increased combined force. In another example, the force produced by the residual stress and the force produced by the haptic actuator may be applied in the different directions to produce a resulting force in a combined direction. In yet another example, the force produced by the residual stress and the force produced by the haptic actuator may be applied in opposite directions resulting in force dampening or cancellation.

Embodiments of the present invention advantageously provide a method of manufacturing a haptic system. A substrate is deformed into a deformed shape. While maintaining the substrate in the deformed shape, an epoxy is applied to the substrate, a haptic actuator is affixed to the epoxy, and the epoxy is cured. After the epoxy has cured, the substrate is released to create a region in the substrate having a residual stress. The haptic actuator is configured to generate a haptic effect in response to receiving a haptic effect signal, and the haptic effect is advantageously amplified by the residual stress associated with the region.

In the various embodiments, the haptic actuator may be a Macro Fiber Composite (MFC) actuator. The residual stress may be created in the region during the process of attaching the MFC actuator to the substrate, as discussed in more detail below. Alternatively, the residual stress may be created during the formation of the substrate.

In many embodiments, the haptic effect is a kinesthetic haptic effect that has a frequency of at least 0.5 Hz. In certain embodiments, the kinesthetic haptic effect that has a frequency between about 0.5 Hz to about 4 Hz( or higher in other embodiments). Additionally, tactile haptic effects can be provided from about 50 Hz up to about 1,000 Hz.

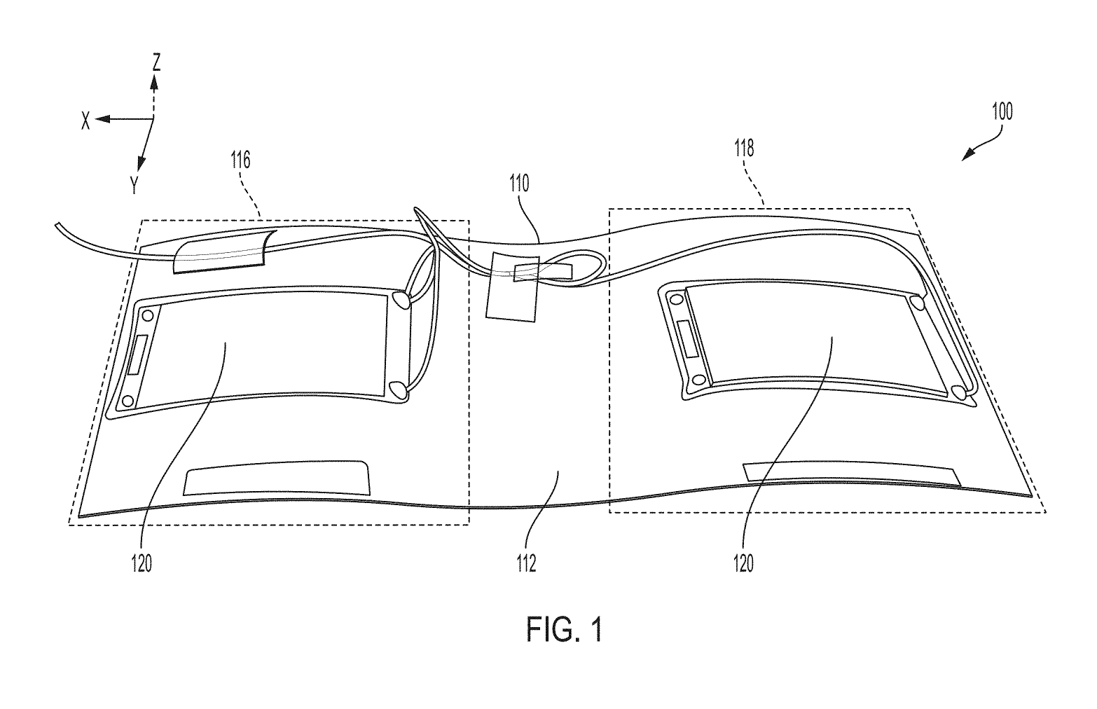

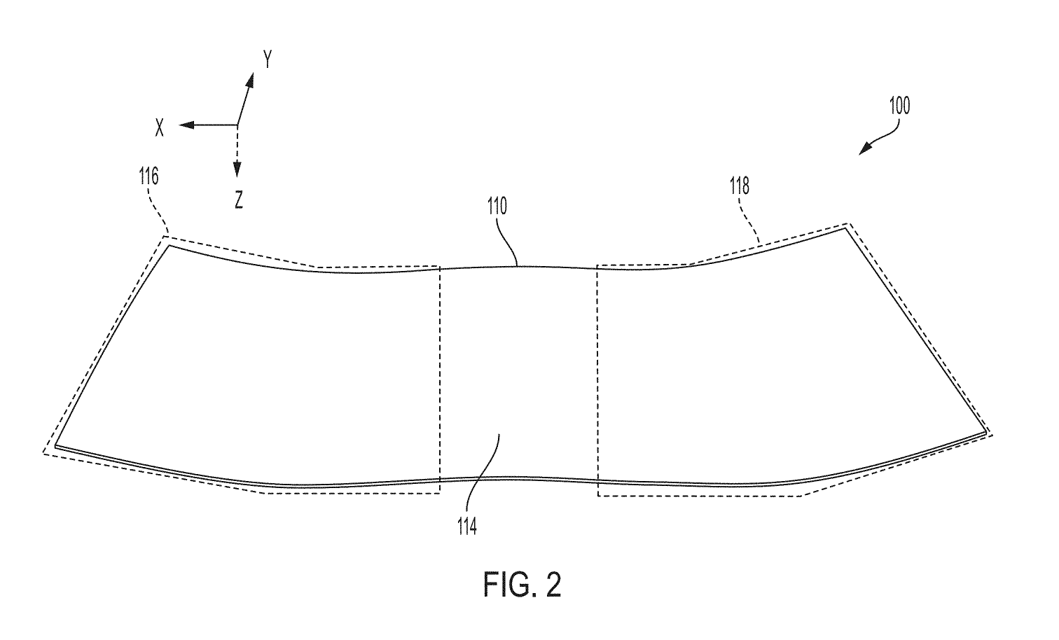

FIGS. 1 and 2 depict a haptic system 100, in accordance with an example embodiment of the present invention.

Haptic system 100 includes a substrate 110, such as, for example, a surface, a thin steel plate or sheet, a thin aluminum plate or sheet, a thin composite sheet, an ultra-thin, flexible glass sheet, a Plexiglas sheet, etc. In one embodiment, substrate 110 is a steel sheet having a thickness of 0.1 mm. Substrate 110 is generally formed from an elastic material. In certain embodiments, substrate 110 may have a gradient in thickness to enhance the amplification effect.

In this example embodiment, substrate 110 may have a rectangular shape in the x-y plane. In other embodiments, substrate 110 can have an oval shape, a round shape, a triangular shape, a curved shape, a semi-curved shape, a C-shape, an asymmetrical shape, etc. Generally, the shape of substrate 110 may be determined by the physical constraints of the device in which haptic system 100 is incorporated. For example, substrate 110 may be integrated into, or form a part of, a display or touchscreen of an electronic device. Similarly, substrate 110 may be integrated into, or form a part of, a display or touchscreen of a separate device coupled to the electronic device, such as, for example, a video game controller, etc.

Substrate 110 has a first side 112 and a second side 114.

In this embodiment, substrate 110 includes regions 116 and 118. In other embodiments, substrate 110 may include a single region or more than two regions. Advantageously, a residual stress has been induced into the material of substrate 110 in these regions. While regions 116 and 118 are depicted with a central region disposed therebetween, in other embodiments, regions 116 and 118 may abut one another.

In this embodiment, two haptic actuators 120 are coupled to side 112, one for each region. For example, haptic actuators 120 may be MFC actuators that are attached to the side 112 using epoxy. Other haptic actuators may be used as well, including, for example, smart actuators, such as piezo-ceramics, electroactive polymers (e.g., dielectric elastomer, polyvinylidene fluoride (PVDF), homo- or co- or ter-polymer), shape memory alloys (SMA), etc. In certain embodiments, haptic actuators 120 may include a combination of different actuator types. In certain embodiments, haptic actuators 120 may be arranged as a single layer, while in other embodiments, haptic actuators 120 may be arranged in multiple layers, such as, for example, a stack.

Generally, an MFC actuator is formed by depositing (e.g., inserting, layering, sandwiching, etc.) rectangular, ribbon-shaped piezo-ceramic rods between layers of adhesive, electrodes and polyimide film. The electrodes are coupled to the film in an interdigitated pattern in order to transfer the applied voltage to, and from, the piezo ceramic rods. An MFC actuator may be coupled to substrate 110 as a thin, surface-conformable sheet.

In certain embodiments, the thickness of the MFC actuator may be approximately 0.5 mm. Alternatively, the thickness of the MFC actuator may be less than 0.5 mm, such as, for example, 10 μm to 100 μm, or more than 0.5 mm, such as, for example, about 2 to 3 mm, about 1 to 2 mm, or less than 1 mm. In certain embodiments, haptic actuator 120 is the “MFC M5628 P1” from Smart Material Corp.

In this embodiment, regions 116 and 118 have a curved profile in the x-z plane, and residual stress has been induced into regions 116 and 118 during the process of attaching haptic actuators 120 to the side 112 of substrate 110. In an embodiment, residual stress may be induced as follows. In one embodiment, substrate 110 has an initial flat shape. Substrate 110 is then deformed prior to the attachment of an MFC actuator to side 112 using epoxy, and held in the deformed shape during the curing cycle of the epoxy. After the epoxy has cured, thereby attaching, or bonding, the MFC actuator to the side 112, substrate 110 will retain the deformed shape due to the “freezing” effect of the epoxy. More particularly, the epoxy prevents the transition of substrate 110 from the deformed shape back to the initial flat shape. In other embodiments, the deformed shape of substrate 110 may take many other forms.

In other embodiments, residual stress may be induced in regions 116 and 118 during the formation of substrate 110. Advantageously, an MFC actuator may be added to a pre-stressed region of a surface or substrate to take advantage of the residual stress associated with the surface or substrate during the rendering of a haptic effect.

During the generation of a haptic effect, at least a portion of the residual stress induced in regions 116 and 118 is released, which advantageously amplifies the haptic effect generated by haptic actuators 120. The amplification provided by the residual stress not only produces a larger haptic effect level for a given power input, but also consumes less power to produce a given haptic effect level.

The amplification effect is most significant at low frequencies, such as, for example, a frequency of at least 0.5 Hz. In certain embodiments, the frequency is between about 0.5 Hz and about 4 Hz. In other embodiments, the frequency is greater than 4 Hz but less than 50 Hz. Both kinesthetic and tactile haptic effects are amplified, with tactile haptic effects begin generated up to about 1000 Hz. Additionally, or alternatively, the amplification effect may be relied upon to utilize lower power actuators while maintaining the strength of the haptic effects.

As shown in FIGS. 1 and 2, haptic system 100 includes a substrate 110 that is configured to amplify the haptic effect rendered on a surface. The amplified haptic effect may be rendered on a surface of any haptically-enabled electronic device in numerous configurations. For example, the amplified haptic effect may be rendered on a display or other surface of a portable communication device such as a mobile phone or tablet. In another example, the amplified haptic effect may be rendered on a surface of a wearable device, such as an augmented or virtual reality device, smart watch, or haptically-enabled eyeglasses. In yet another example, the amplified haptic effect may be rendered on an automobile panel, such as a dashboard panel or steering wheel in order to provide a warning or alert to a driver. In yet another example still, the amplified haptic effect may be rendered on a seat, such as an automobile seat, that includes a substrate coupled to a haptic-enabled fabric. These example configurations are not exhaustive, and it should be understood that the embodiments of the present invention may be readily applied to a surface of any haptically-enabled electronic device, such as a game console, musical instrument (e.g., piano keys), personal computers and laptops (including a keyboard and/or mouse), etc.

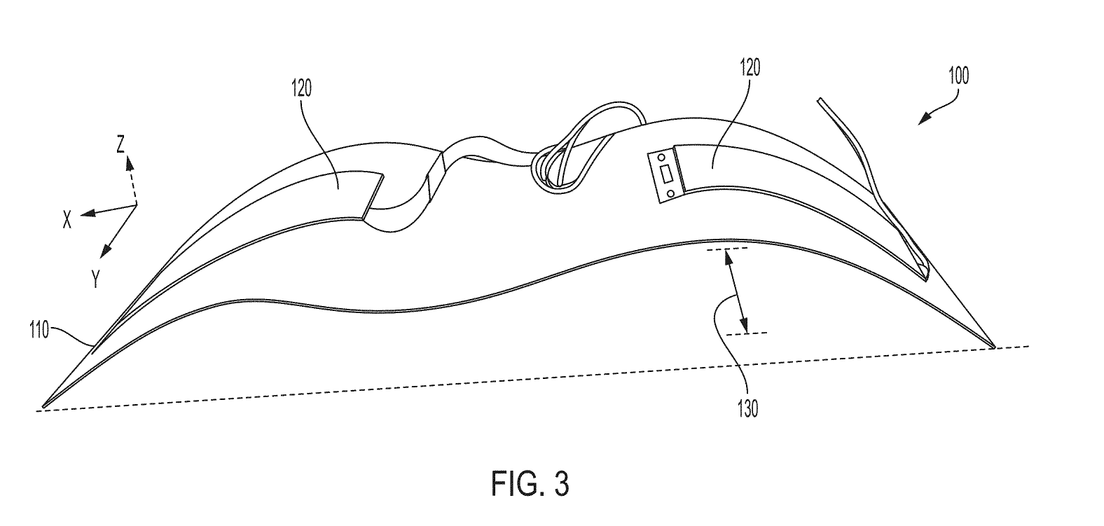

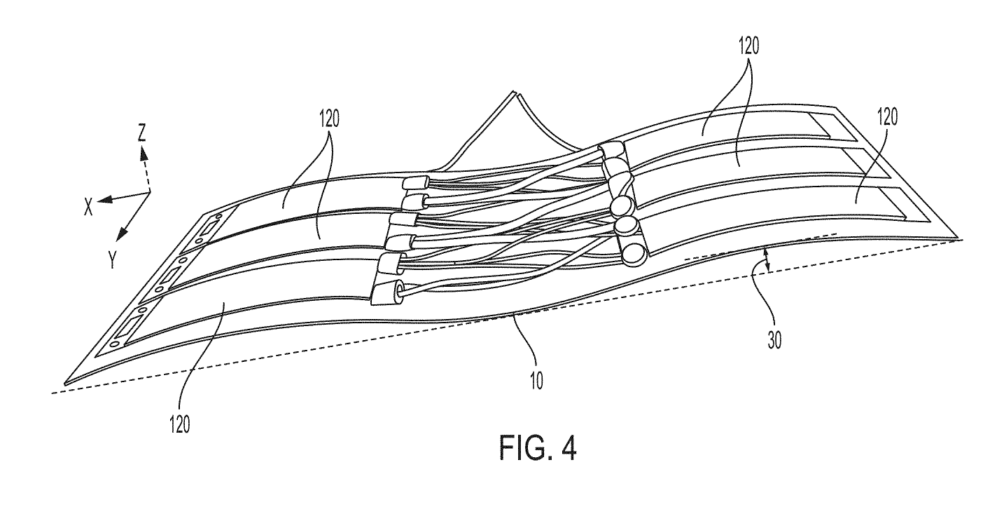

FIG. 3 depicts haptic system 100 producing a low frequency haptic effect of about 4 Hz, while FIG. 4 depicts a rectangular substrate 10 producing a low frequency haptic effect of about 4 Hz.

As can be seen, displacement 130 in the Z direction for haptic system 100 is 3 to 4 times as large as displacement 30 in the Z direction for the example rectangular substrate 10. Six (6) haptic actuators 120 were used to provide the haptic effect for example rectangular substrate 10, while only two (2) haptic actuators 120 were used to provide the haptic effect for haptic system 100. Because less input power was used to create the haptic effect for system 100, the residual stresses induced in regions 116 and 118 advantageously amplify the haptic effect provided by haptic actuators 120 in haptic system 100 by at least a factor of four (4).

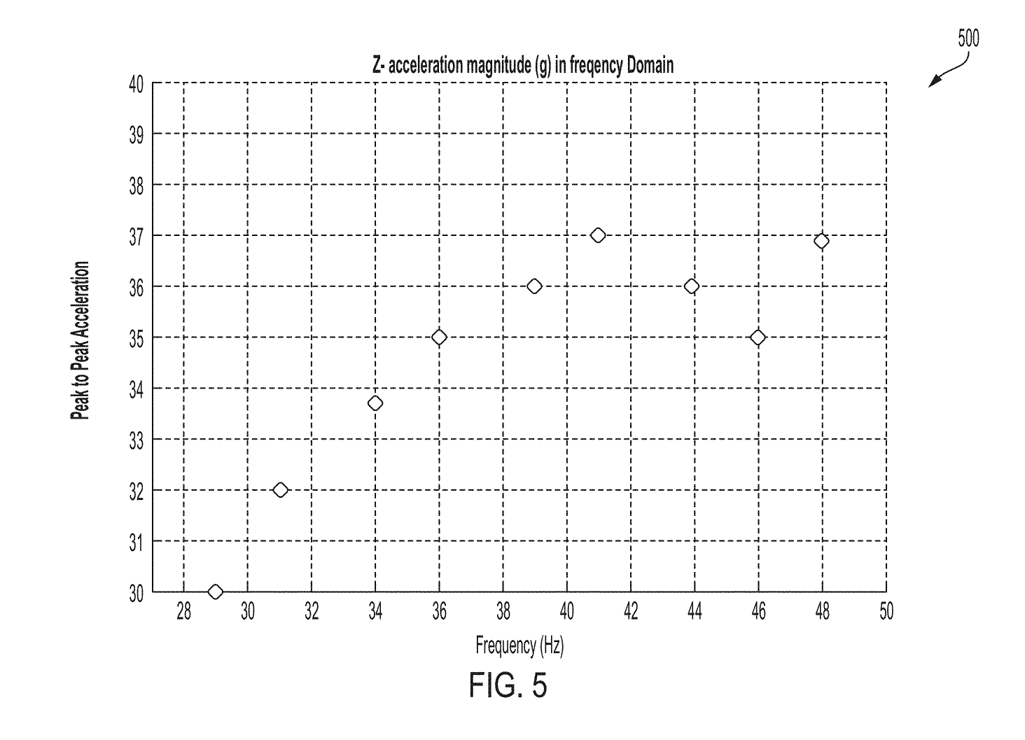

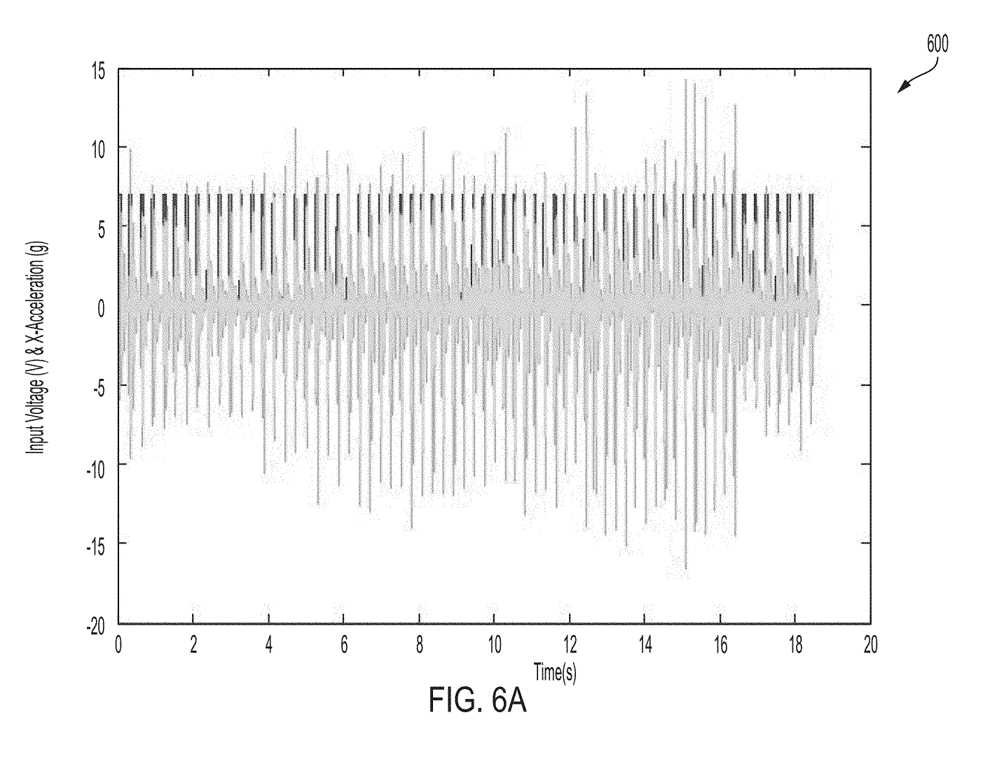

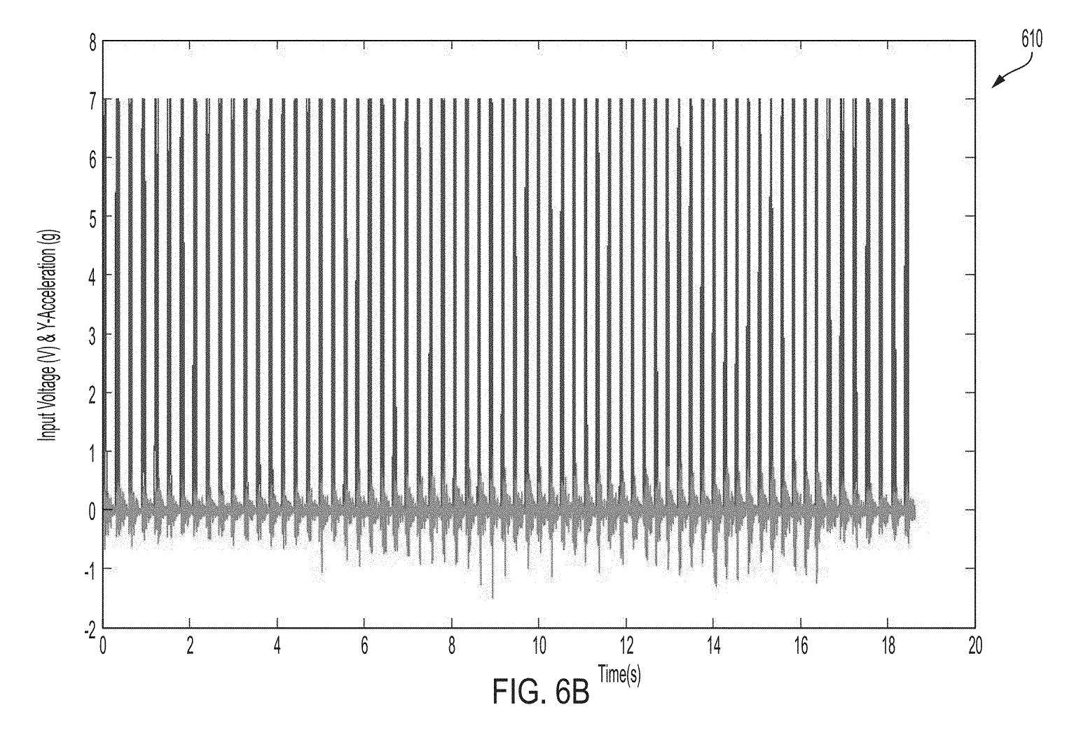

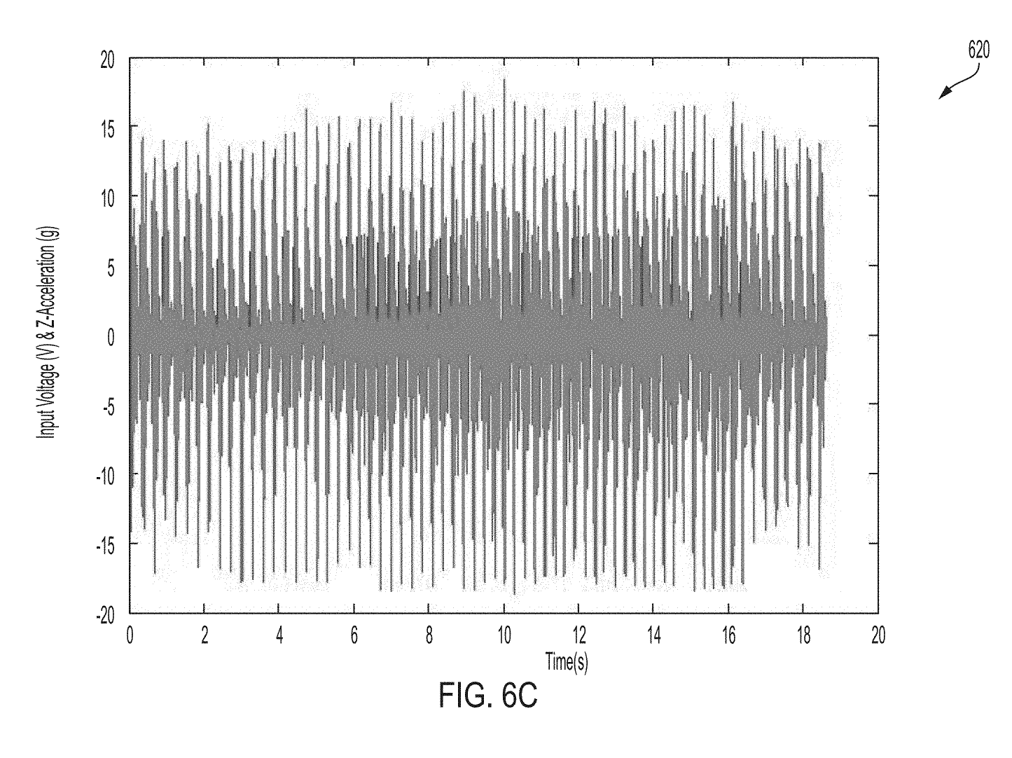

FIGS. 5, 6A, 6B, and 6C present measured acceleration (Z direction) and acceleration data (X, Y and Z directions) for a frequency sweep of haptic system 100, in accordance with example embodiments of the present invention. In this example, substrate 110 is formed from a steel sheet having a thickness of 0.1 mm and has two regions, and two MFC actuators have been epoxy-bonded to side 112. The frequency sweep was conducted from 29 Hz to 48 Hz.

FIG. 5 presents a graph 500 of Z-acceleration magnitude (g, peak-to-peak) vs. frequency (Hz). FIG. 6A presents a graph 600 of input voltage (V) and X-acceleration (g) vs. time (sec). FIG. 6B presents a graph 610 of input voltage (V) and Y-acceleration (g) vs. time (sec). FIG. 6C presents a graph 620 of input voltage (V) and Z-acceleration (g) vs. time (sec).

FIGS. 6A, 6B and 6C, the blue line corresponds to a scaled input signal (scaled down 200×), and the green/magenta/red lines are the measured acceleration. The haptic actuators 120 were driven at 70% of their full power rating, which indicates that even greater force and displacement may be achieved by driving haptic actuators 120 at full power. As can be seen by these graphs, even at this low frequency range and 70% power setting, the MFC actuator advantageously provides at least enough output acceleration to be perceived by the user. For example, a user may perceive haptic feedback having a force as low as 30 mN or 40 mN (e.g., having a force of at least 30 mN or 40 mN, or having a force within a range within a range of 30 mN to 40 mN), and the output acceleration may vary according to the mass of the haptic actuator to produce a force perceptible to a user.

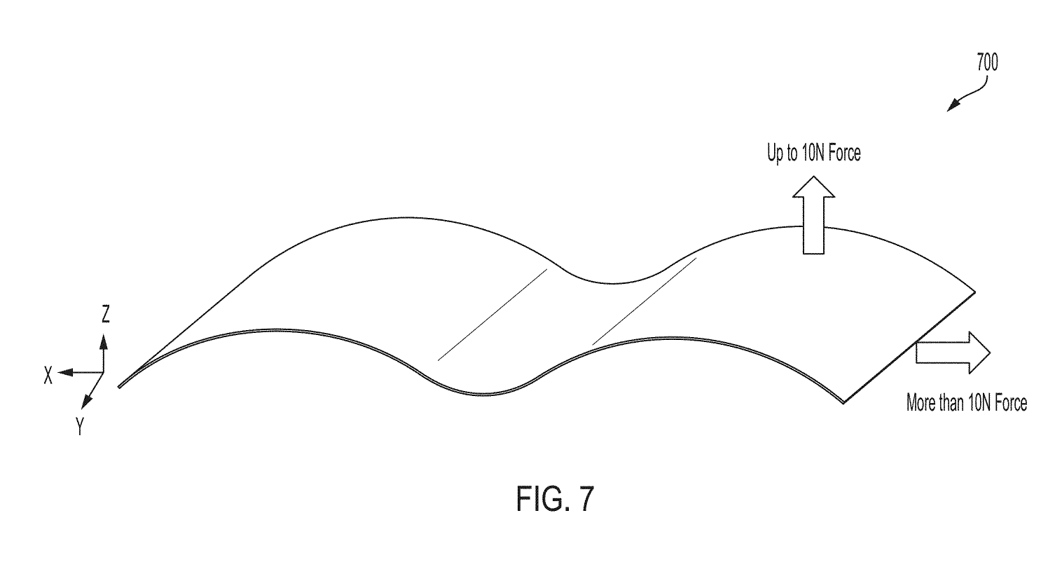

FIG. 7 depicts the direction and magnitude of the output forces produced by haptic system 100, according to an embodiment of the present invention. In certain embodiments, for a haptic effect having a frequency of 0.5 Hz, up to 10N of normal force may be provided along the Z-axis, and more than 10N of force may be provided along the X-axis.

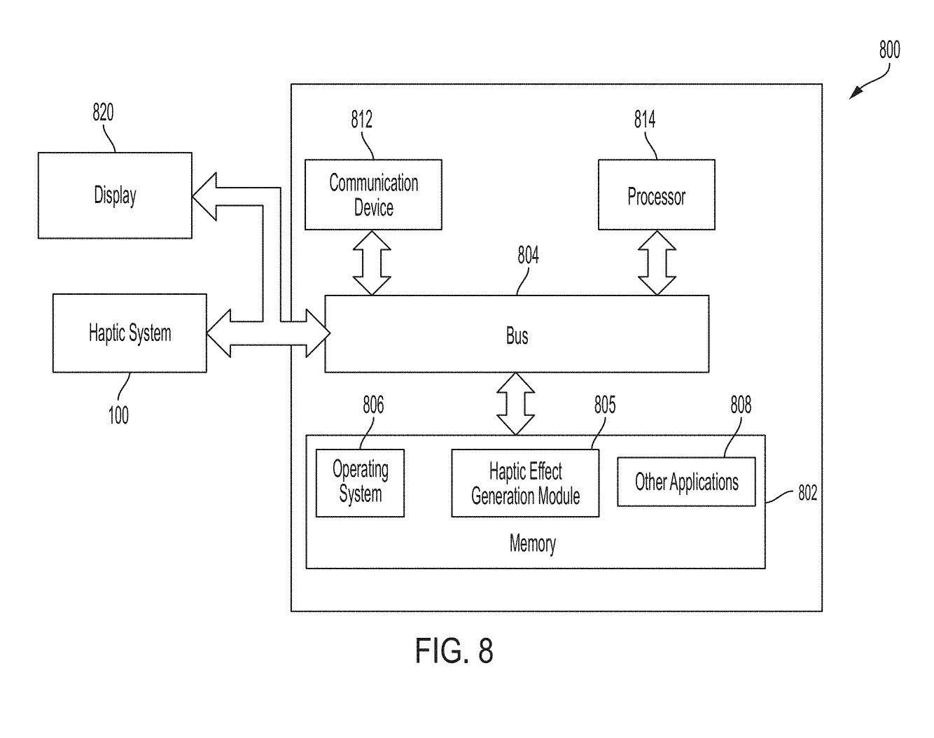

FIG. 8 is a block diagram of a haptically-enabled device 800, in accordance with an embodiment of the present invention.

Although shown as a single system, the functionality of haptically-enabled device 800 can be implemented as a distributed system. Haptically-enabled device 800 includes a bus 804 or other communication mechanism for communicating information, and a processor 814 coupled to bus 804 for processing information. Processor 814 can be any type of general or specific purpose processor. Haptically-enabled device 800 further includes a memory 802 for storing information and instructions to be executed by processor 814. Memory 802 can be comprised of any combination of random access memory (“RAM”), read only memory (“ROM”), flash memory, solid state memory, static storage such as a magnetic or optical disk, or any other type of non-transitory computer-readable medium.

A non-transitory computer-readable medium can be any available medium that can be accessed by processor 814, and can include both a volatile and nonvolatile medium, a removable and non-removable medium, and a storage medium. A storage medium can include RAM, flash memory, ROM, solid state memory, erasable programmable read-only memory (“EPROM”), electrically erasable programmable read-only memory (“EEPROM”), registers, a hard disk, a removable disk, a compact disk read-only memory (“CD-ROM”), or any other form of a storage medium known in the art.

According to an example embodiment, memory 802 stores software modules that provide functionality when executed by processor 814. The software modules include an operating system 806 that provides operating system functionality for haptically-enabled device 800, as well as the rest of the haptically-enabled device 800. The software modules can also include haptic effect generation module 805 that generates haptic effect signals. The software modules further include other applications 808, such as, a video-to-haptic conversion algorithm.

Haptically-enabled device 800 can further include a communication device 812 (e.g., a network interface card) that provides wireless network communication for infrared, radio, Wi-Fi, or cellular network communications. Alternatively, communication device 812 can provide a wired network connection (e.g., a cable/Ethernet/fiber-optic connection, or a modem).

Processor 814 is further coupled via bus 804 to a visual display 820 for displaying a graphical representation or a user interface to an end-user. Visual display 820 can be a touch-sensitive input device (i.e., a touch screen) configured to send and receive signals from processor 814 and can be a multi-touch touch screen.

Haptically-enabled device 800 also includes haptic system 100 (described above). Processor 814 transmits a haptic signal associated with a haptic effect to haptic system 100, which in turn outputs kinesthetic and/or tactile haptic effects using one or more haptic actuators 120. In many embodiments, haptic system 100 may be integrated into display 820.

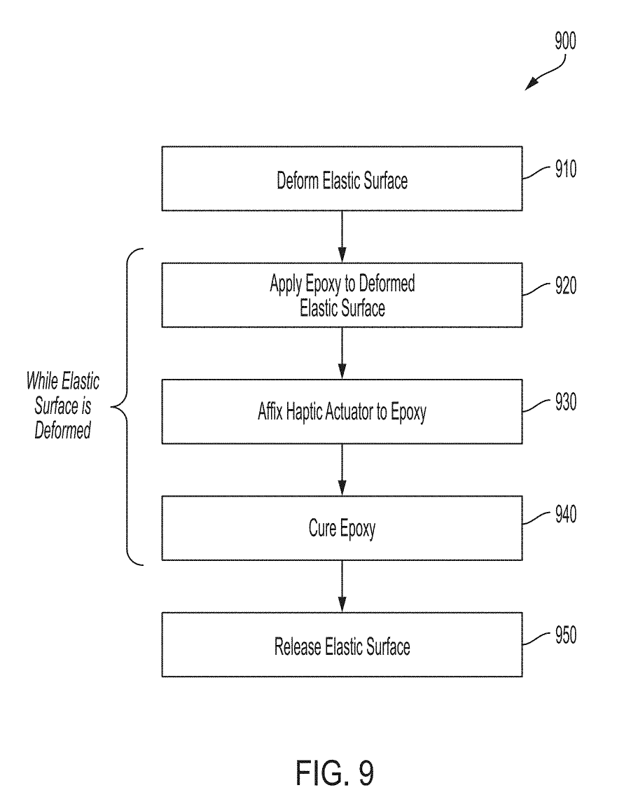

FIG. 9 depicts a flow chart illustrating functionality for manufacturing a haptic system, in accordance with an embodiment of the present invention.

With respect to embodiment 900, at 910, an elastic substrate is deformed into a deformed shape.

While holding the elastic substrate in the deformed shape, at 920, an epoxy is applied to the elastic substrate, at 930, a haptic actuator is affixed to the epoxy, and at 940, the epoxy is cured. The haptic actuator is configured to generate a haptic effect in response to receiving a haptic effect signal.

After the epoxy has cured, at 950, the elastic substrate is released to create a region in the elastic substrate having a residual stress.

The haptic effect generated by the haptic actuator is amplified by the residual stress associated with the region.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A haptic system, comprising:
a substrate including a region having a residual stress; and
a haptic actuator, associated with the substrate on or near the region, configured to generate a haptic effect in response to receiving a haptic effect signal, the haptic effect being amplified by the residual stress associated with the region.

2. The haptic system according to claim 1, wherein the haptic actuator is a Macro Fiber Composite (MFC) actuator.

3. The haptic system according to claim 2, wherein a thickness of the MFC actuator is between 0.1 mm to 0.5 mm.

4. The haptic system according to claim 1, wherein the haptic actuator is a piezo-ceramic actuator, an electroactive polymer, or a shape memory alloy (SMA).

5. The haptic system according to claim 1, wherein the residual stress is created in the region by coupling of the haptic actuator to the substrate.

6. The haptic system according to claim 1, wherein the residual stress is created during formation of the substrate.

7. The haptic system according to claim 1, wherein the haptic effect is a kinesthetic haptic effect having a frequency of at least 0.5 Hz.

8. The haptic system according to claim 7, wherein the frequency between about 0.5 Hz to about 4 Hz.

9. The haptic system according to claim 1, wherein the haptic effect is a tactile haptic effect having a frequency between about 50 Hz up to about 1,000 Hz.

10. The haptic system according to claim 1, wherein the substrate has a gradient in thickness.

11. The haptic system according to claim 1, wherein the substrate is integrated into a display.

12. The haptic system according to claim 1, further comprising:
one or more additional haptic actuators, each additional haptic actuator being configured to generate an additional haptic effect in response to receiving an additional haptic effect signal,
wherein the substrate includes one or more additional regions, each additional region having a residual stress, and
wherein each additional haptic actuator is associated with the substrate on or near a respective additional region.

13. The haptic system according to claim 12, wherein the additional haptic effect signal is the haptic effect signal.

14. The haptic system according to claim 12, wherein the additional regions abut one another.

15. The haptic system according to claim 12, wherein the additional haptic actuators are arranged in one or more stacks.

16. A method of manufacturing a haptic system, comprising:
deforming an substrate into a deformed shape;
while holding the substrate in the deformed shape:
applying an epoxy to the substrate,
affixing a haptic actuator to the epoxy, the haptic actuator being configured to generate a haptic effect in response to receiving a haptic effect signal, and
curing the epoxy; and
after the epoxy has cured, releasing the substrate to create a region in the substrate having a residual stress,
wherein the haptic effect generated by the haptic actuator is amplified by the residual stress associated with the region.

17. The method of manufacturing according to claim 16, wherein the haptic actuator is piezo-ceramic actuator, an electroactive polymer, or a shape memory alloy (SMA).

18. The method of manufacturing according to claim 16, wherein the haptic effect is a kinesthetic haptic effect having a frequency between about 0.5 Hz to about 4 Hz or a tactile haptic effect having a frequency between about 50 Hz up to about 1,000 Hz.

19. The method of manufacturing according to claim 16, wherein the substrate is integrated into a display.

20. A method for rendering a haptic effect, the method comprising:
inducing a residual stress in a region of a substrate;
receiving, at an actuator, a haptic effect signal configured to generate a haptic effect, the haptic actuator being associated with the substrate on or near the region; and
amplifying the haptic effect by the residual stress associated with the region.
